(19) United States
(12) Patent Application Publication
(10) Pub. No.: US 2009/0305530 A1
(43) Pub. Date: Dec. 10, 2009

(54) Board Mounted Connector

(75) Inventors: Naotoshi Ito, Tokyo (JP); Kazushige Asakawa, Kanagawa (JP)

Correspondence Address: MOLEX INCORPORATED, 2222 WELLINGTON COURT, LISLE, IL, 60532, US

(73) Assignee: NOKIA CORPORATION, ESPOO (FI)

(21) Appl. No.: 11/922,373

(22) PCT Filed: May 10, 2006
(86) PCT No.: PCT/US2006/017951

§ 371 Date: Feb. 23, 2009

(30) Foreign Application Priority Data
Jun. 30, 2005 (JP) 2005-190845

(51) Int. Cl. H01R 12/00

(52) U.S. Cl. 439/80

(57) ABSTRACT

A board mounted connector designed to have side surfaces forming a generally rectangular cross section so that a board mounted cover with a generally rectangular inner opening can easily slip over the connector housing. The connector has a housing having a bottom surface facing the circuit board, two end surfaces and two side surfaces extending upwardly from the peripheral edge of the bottom surface, the end and side surfaces forming planes which extend from the peripheral edge of the bottom surface to be perpendicular to the bottom surface. The end and side surfaces defining a peripheral wall with upper and lower portions all of which are located within the planes extending from the peripheral edge of the bottom surface.

### BACKGROUND OF THE INVENTION

1. Field of the Invention

The present invention relates to a board mounted connector.

2. Description of the Related Art

Many board mounted connectors have been used to connect a cable to a circuit board. FIG. 8 is a perspective view of such a connector and a mating cable connector. This connector appears in the Japanese Patent Application Laid-Open (kokai) No. 2000-123912). The reference numeral 301 in FIG. 8 denotes a circuit board having conductive traces (not shown) formed thereon, and a board mounted connector 302. A cable connector 304, which is connected to end portions of a plurality of parallel wires 303, is inserted into the board mounted connector 302. The board mounted connector 302 includes a housing 305 formed into a generally parallelepiped shape from an insulating material such as synthetic resin and a plurality of terminals 306 disposed in parallel within the housing 305. The terminals 306 pass through the bottom wall of the housing 305 and project downwardly. The downwardly projecting ends 307 are inserted into through-holes 308 formed in the circuit board 301 and are fixed thereto by means of soldering or any other suitable process. Thus, the terminals 306 are electrically connected to conductive traces connected to the through-holes, and fix the housing 305 to the circuit board 301.

The cable connector 304 is inserted into an opening facing upwardly of the board mounted connector 302, whereby terminals (not shown) of the cable connector 304 are connected to the terminals 306 of the board mounted connector 302. Thus, the conductors of wires 303 are electrically connected to the corresponding conductive traces of the circuit board 301.

This type of connector is used in electronic equipment or a game machine such as a “pachinko” machine or a “pachinko-slot” machine. If used properly a game player can receive rewards. To register false numbers, which can result in the receipt of illegal rewards, a game player can move a conductive probe into a clearance between the surface of the circuit board and the lower edges of the side surfaces of the connector mounted to the circuit board until the probe engages one or more terminals.

In order to prevent such an illegal action or tampering, a sheet-shaped or plate-shaped tamper-proof cover formed of resin has been placed around the lower edges of the side surfaces of the board mounted connector after the board mounted connector is soldered to the board. This will allow for the inspection of the solder joint. The tamper-proof cover has a thickness equal to or greater than a predetermined thickness of about 0.2 mm and can prevent insertion of a probe into a clearance between the surface of the circuit board and the lower edges of the side surfaces of the board mounted connector.

The tamper-proof cover has an adhesive layer which is bonded to the surface of the circuit board surrounding the board mounted connector. Since the inner edge of the tamper-proof cover must be brought as close as possible to the circumference of the lower edges of the side surfaces of the board mounted connector, an opening, which matches the transverse shape and size of the entire board mounted connector, is formed in the tamper-proof cover. The board mounted connector must pass through the opening in the cover.

However, since the housing 305 of the board mounted connector 302 has ribs 310 and hooks 311 formed on the side surface thereof, its transverse cross section is not a simple rectangle. Instead it is a complicated shape which is more difficult to form. Further, because the ribs 310 and the hooks 311 extend beyond the simple transverse shape of the connector housing, a large clearance or gap is formed between the inner edge of the tamper-proof cover and the lower edges of the side surfaces of the housing 305. This gap is a result of the extra portion cut from the cover to allow the cover to pass over the ribs 310 and hooks 311. The existence of this gap will provide a new location for the insertion of the probe.

### SUMMARY OF THE INVENTION

An object of the present invention is to solve the above-mentioned problems in the conventional board mounted connector and to provide a reliable board mounted connector which is configured such that the side surfaces of a housing do not project outward from the contour of the bottom surface of the housing when viewed from above, to thereby enable easy bonding of a tamper-proof cover having an opening to a circuit board and prevent formation of a gap between the opening of the tamper-proof cover and the lower edges of the side surfaces of the housing.

In order to achieve the above object, the present invention provides a board mounted connector comprising a housing which is mated with a counterpart connector and terminal members attached to the housing. The terminals are connected to a circuit board and come into contact with corresponding terminal members of the counterpart connector. The housing has a bottom surface facing the circuit board, and side surfaces extending upwardly from the peripheral edge of the bottom surface. The side surfaces do not have a portion which projects outwardly from planes which extend from the peripheral edge of the bottom surface to be perpendicular to the bottom surface.

Preferably, at least within a predetermined vertical range as measured from the bottom surface, the side surfaces are flush with the planes which extend from the bottom surface to be perpendicular to the bottom surface.

Preferably, the side surfaces include a cutaway whose lower end is opened outwardly at a boundary between the bottom surface and the side surfaces, the upper end of the cutaway being located within the predetermined vertical range.

Preferably, the bottom surface includes a recess portion which communicates with the cutaway and surrounds the terminal members.

Preferably, the peripheral edge of the bottom surface forms a rectangular contour.

Preferably, the circuit board has a surface around the housing to which a cover member can be bonded, and the cover member has an opening which is identical in shape and size with the contour of the bottom surface.

In the board mounted connector according to the present invention, the side surfaces of the housing do not project outward from the contour of the bottom surface of the housing when viewed from above. Therefore, it becomes possible to easily bond a tamper-proof cover having an opening to a circuit board, and prevent formation of a gap between the opening of the tamper-proof cover and the lower edges of the side surfaces of the housing, whereby tamper proof reliability can be improved.

These and other objects, features and advantages of the present invention will be clearly understood through a consideration of the following detailed description.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a board mounted connector according to an embodiment of the present invention prior to being mated with a counterpart connector;

FIG. 2 is a transverse sectional view of the board mounted connector and the counterpart connector after being mated;

FIG. 3 is a longitudinal sectional view of the board mounted connector;

FIG. 4 is a front view of the board mounted connector;

FIG. 5 is an upper perspective view of the board mounted connector mounted onto a board with the unmated counterpart connector;

FIG. 6 is a first lower front perspective view of the board mounted connector mounted onto a board with the unmated counterpart connector;

FIG. 7 is a second lower rear perspective view of the board mounted connector mounted onto a board with the unmated counterpart connector; and

FIG. 8 is a perspective view of a conventional board mounted connector in the prior art.

### DESCRIPTION OF THE PREFERRED EMBODIMENT

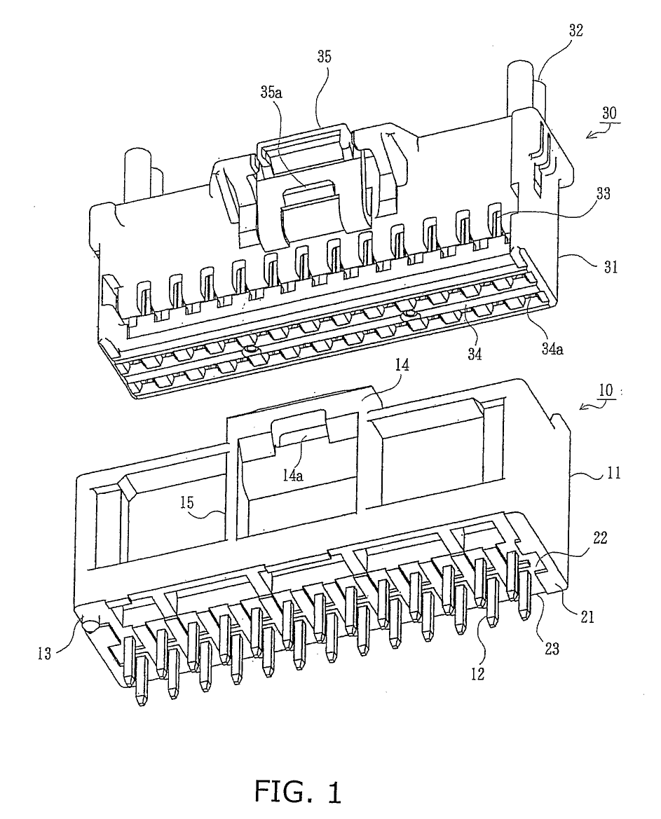

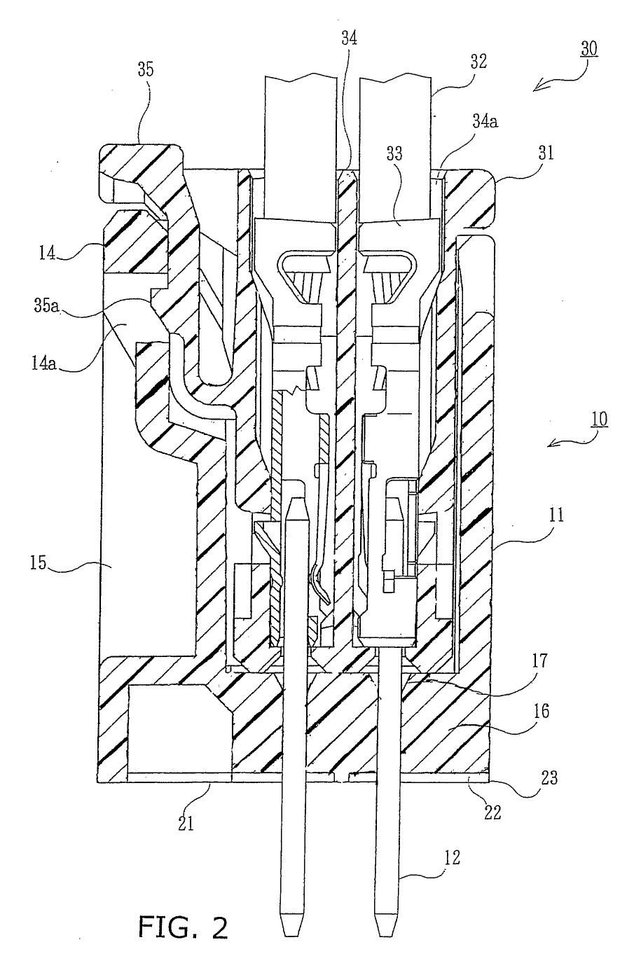

In FIGS. 1 and 2, reference numeral 30 denotes a counterpart connector, according to the present embodiment, which is used to electrically connect a cable including a plurality of wires 32 to a board mounted connector 10. The counterpart connector 30 may be used not only for connection of the illustrated cable which includes the wires 32 each having a circular cross section, but also for connection of a plate-shaped flexible cable such as a flexible flat cable (FFC) or flexible printed circuit (FPC). In the present embodiment, terms for expressing direction, such as up, down, left, right, front, and rear, are used for explaining the structure and action of respective portions of the board mounted connector 10 and the counterpart connector 30. However, these terms represent respective directions in the orientation shown in the drawings of the board mounted connector 10 and the counterpart connector 30.

The board mounted connector 10 is a receptacle connector, and includes a housing or connector body 11 and terminals or terminal members 12. The housing 11 is formed from an insulative material such as a synthetic resin, and is mated with the counterpart connector 30. The terminals 12 are formed of metal and attached to the housing 11 such that the terminals 12 pass through a bottom wall 16 of the housing 11. As shown in FIG. 2, terminal insertion holes 17 are formed through the bottom wall 16 of the housing 11. The terminals 12, which are members to be connected to a board 41, are designed to engage wire terminals 33 of the counterpart connector 30. The terminals 12 are slid into the terminal insertion holes 17 and are fixed to the bottom wall 16 of the housing 11. In the illustrated example, the terminals 12 are arranged in two rows at a pitch of 2.0 mm. However, the number and pitch of the terminals 12 and the number of terminal rows can be freely changed. For example, the terminals 12 may be arranged to form a single terminal row or multiple terminal rows. The terminals 12 are not necessarily required to be inserted into all the terminal insertion holes 17. For example, some of the terminals 12 may be omitted such that the arrangement of the terminals 12 matches the arrangement of the wires 32 of the counterpart connector 30. At one corner of the bottom wall 16 of the housing 11, a positioning projection 13 projecting downwardly is formed integrally with the bottom wall 16.

The housing 11 has a generally parallelepiped shape, and its upper end opposite the bottom wall is opened outwardly. The opening serves as an insertion aperture into which the counterpart connector 30 is inserted. A lock engagement member 14 is integrally formed with the housing 11 to be located near the upper edge of one side surface of the housing 11. The lock engagement member 14 comes into engagement with an engagement arm portion 35 of the counterpart connector 30 to thereby lock the counterpart connector 30 with an end portion of the cable. An engagement opening 14a is formed in the lock engagement member 14 for engagement with an engagement projection 35a of the engagement arm portion 35.

The board mounted connector 10 is a straight-type connector. The tip ends of the terminals 12 are soldered to the board 41, whereby the board mounted connector 10 is mounted onto the board 41 in an upright position with the insertion aperture facing upwardly.

The counterpart connector 30 is a plug connector and includes a housing or connector body 31 which is formed from an insulative material such as a synthetic resin. The housing 31 assumes a generally parallelepiped shape and has a plurality of terminal accommodation holes 34a defined by partition walls 34 combined to form a grid-like cross section. The terminal accommodation holes 34a are through-holes each having a rectangular cross section and extends from the upper surface to the lower surface of the housing 31.

As shown in FIG. 2, the terminal accommodation holes 34a accommodate the wire terminals or terminal members 33 connected to end portions of the wires 32. The wire terminals 33 are desirably accommodated within the terminal accommodation holes 34a in an engaged state, whereby removal of the wire terminals 33 is prevented. The wire terminals 33 are arranged in the same manner as the terminals 12 of the board mounted connector 10, and are connected to the corresponding terminals 12. The wire terminals 33 are not necessarily required to be inserted into all the terminal accommodation holes 34a. Some of the wire terminals 33 may be omitted such that the arrangement of the wire terminals 33 matches the arrangement of the terminals 12 of the board mounted connector 10.

The above-mentioned engagement arm portion 35, which serves as a lock member, is integrally formed with the housing 31 to be located in the vicinity of the upper edge of one side surface of the housing 31. The engagement arm portion 35 comes into engagement with the lock engagement member 14 of the board mounted connector 10, and enters a locked state. The engagement arm portion 35 is cantilevered such that its one end serves as a free end, and the above-mentioned engagement projection 35a is integrally formed with the engagement arm portion 35 for engagement with the engagement opening 14a of the lock engagement member 14.

As shown in FIG. 2, where the board mounted connector 10 and the counterpart connector 30 are mated with each other, the housing 31 of the counterpart connector 30 is almost completely inserted and accommodated in the housing 11 of the board mounted connector 10, and the engagement arm portion 35 is accommodated in the lock engagement member 14 such that the engagement projection 35a is engaged with the engagement opening 14a and is locked. The inner-lock-type mating is achieved in which the lock engagement member of the counterpart connector 30 is inserted into the interior of the lock member of the board mounted connector 10 and is locked. Therefore, when an operator manipulates the counterpart connector 30 with his or her fingers and/or thumb, the operator can feel a click upon engagement of the engagement projection 35a with the engagement opening 14a. Moreover, since the engagement projection 35a is positioned within the engagement opening 14a only after the connectors are fully mated, a complete lock can also be visually confirmed.

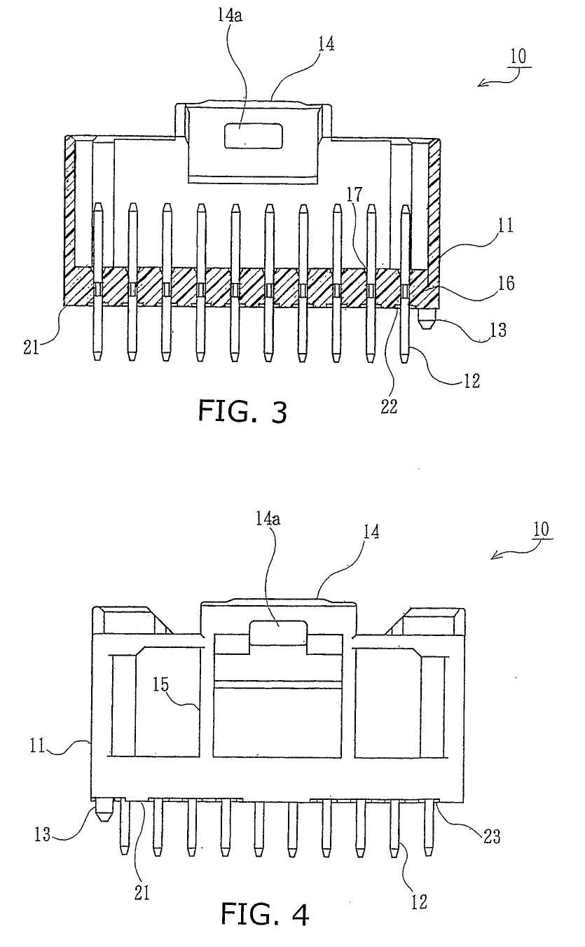

As shown in FIGS. 2 to 4, the end and side surfaces of the housing 11 of the board mounted connector 10 are formed such that no portion of the end and side surfaces project outwardly from the planes which extend upwardly from a contour line of the bottom surface 21 facing the board 41. This contour line, which corresponds to the peripheral edge of the bottom surface 21, is perpendicular to the bottom surface 21. The housing 11 has a generally parallelepiped shape with two lateral end surfaces at the opposite longitudinal ends of the housing 11 and two longitudinal side surfaces. One of the two longitudinal side surfaces, which are at the opposite sides of the housing 11 and which extend along the longitudinal direction of the housing 11, as shown at the right-hand side surface in FIG. 2, is flat. The other longitudinal side surface, as shown at the left-hand side surface in FIG. 2, has concave portions which define the lock engagement member 14 and ribs 15 for reinforcement. Although the other longitudinal side surface of the housing 11, extending along the longitudinal direction, is not flat, this other side surface does not project outwardly beyond a plane vertically extending from the corresponding one of the longitudinally extending sides of the bottom surface 21

As described above, the contour of the bottom surface 21 of the housing 11 is a generally rectangular shape having four sides, and therefore, the opening 42a of the tamper-proof cover 42 to be described later can be easily formed. Further, since the side surfaces of the housing 11 have no portion which projects outwardly from the planes which extend from the peripheral edge of the bottom surface 21 such that the housing 11 can pass through the opening 42a in the tamper-proof cover 42. Since the opening 42a of the tamper-proof cover 42 is identical in planar shape and size with the bottom surface 21, no gap is produced between the inner circumference of the opening 42a and the side surfaces of the housing 11. Moreover, since the side surfaces of the housing 11 are coplanar with the planes vertically extending from the bottom surface 21 at least within a predetermined vertical range as measured from the bottom surface 21, no gap is formed between the inner circumference of the opening 42a and the side surfaces of the housing 11 with respect to the direction perpendicular to the bottom surface 21.

In the example shown in FIGS. 1 to 3, cutaways 23, are formed at boundary areas between the side surfaces and the bottom surface 21 of the housing 11. The lower ends of the cutoffs 23 are opened to the outside at the boundaries between the bottom surface 21 the side surfaces. The upper ends of the cutoffs 23 are located within the above-described vertical range extending from the bottom surface 21 and corresponding to the thickness of a tamper-proof cover 42. Depressions 22 are formed on the bottom surface 21 of the housing 11. The depressions 22 communicate with the cutoffs 23 and surround the terminals 12. This configuration enables heat created during the solder procedure to be discharged from the locations of the soldered terminals 12 to the outside via the depressions 22 and the cutoffs 23. Since the vertical height of the cutoffs 23 is less than the thickness of the tamper-proof cover 42, no gap is formed between the inner circumference of the opening 42a of the tamper-proof cover 42 and the side surface of the housing 11. Although present in this embodiment, the cutoffs 23 and the depressions 22 may be omitted.

Next, the board mounted connector 10 mounted onto the board 41 will be described. In the present embodiment, the board 41 is a printed circuit board, which is used in a game machine such as a “pachinko” machine or a “pachinko-slot,” which is a combination of a pachinko machine and a slot machine. However, the board 41 may be a circuit board used in a computer, an automatic vending machine, a home appliance, or electronic equipment of any type. Moreover, the board 41 has unillustrated conductive traces, and through-holes which penetrate the board 41 in the thickness direction and are electrically connected to the conductive traces.

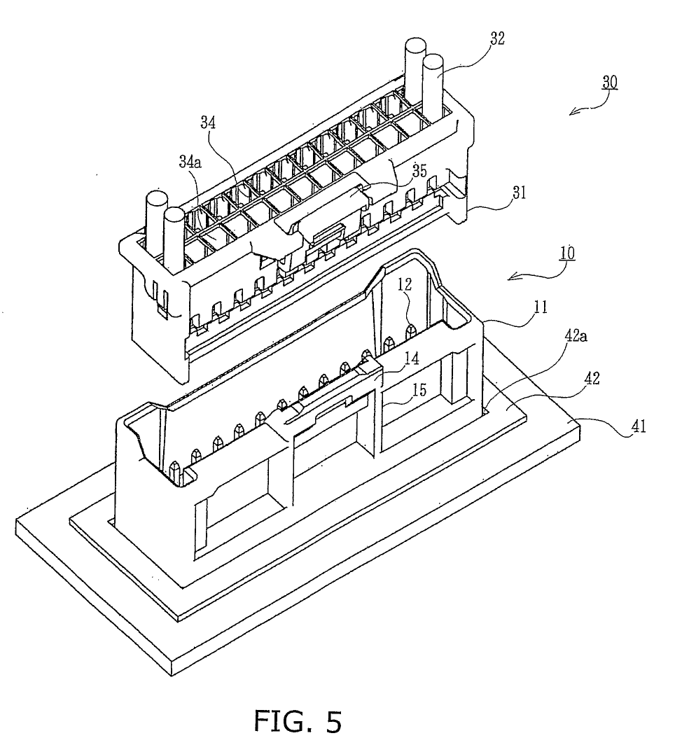

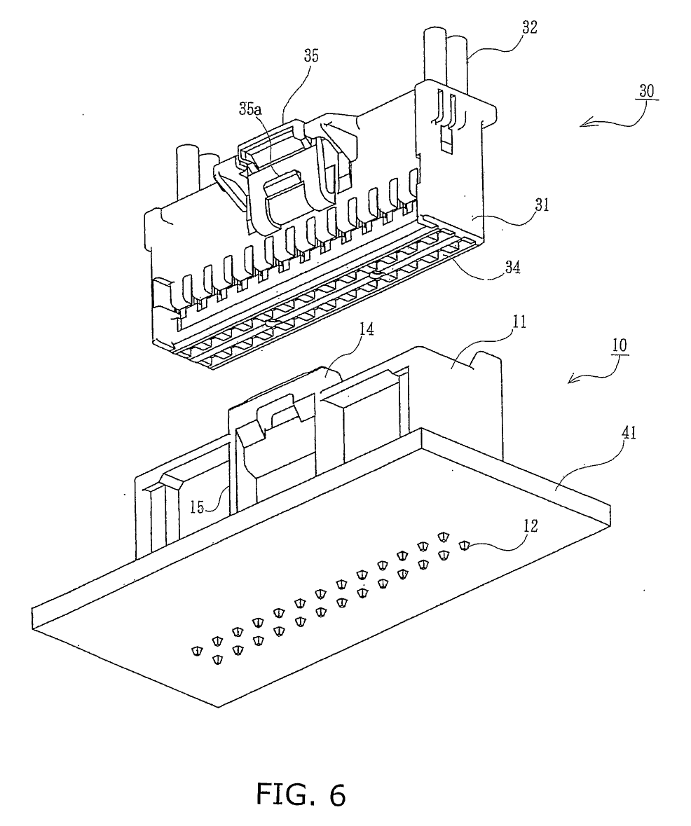

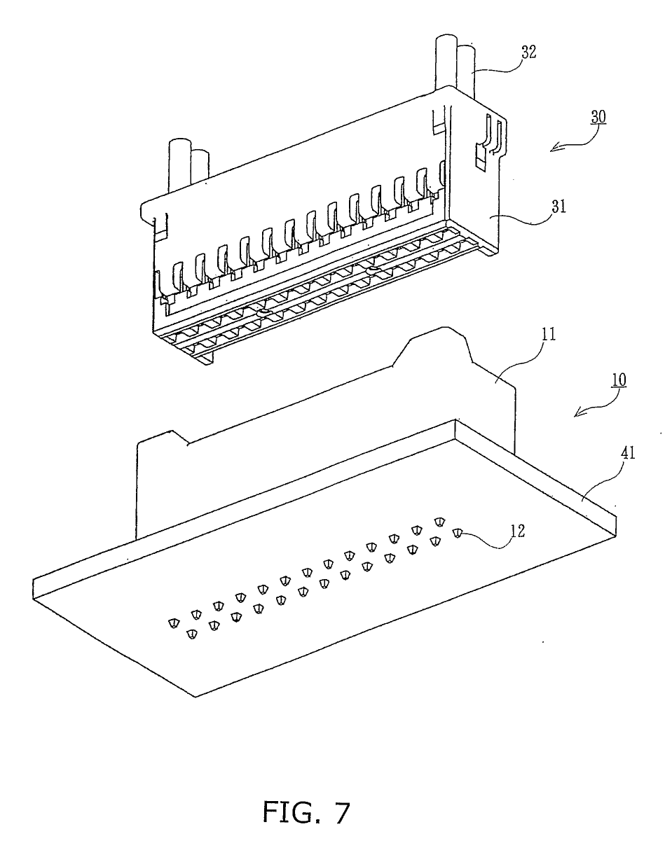

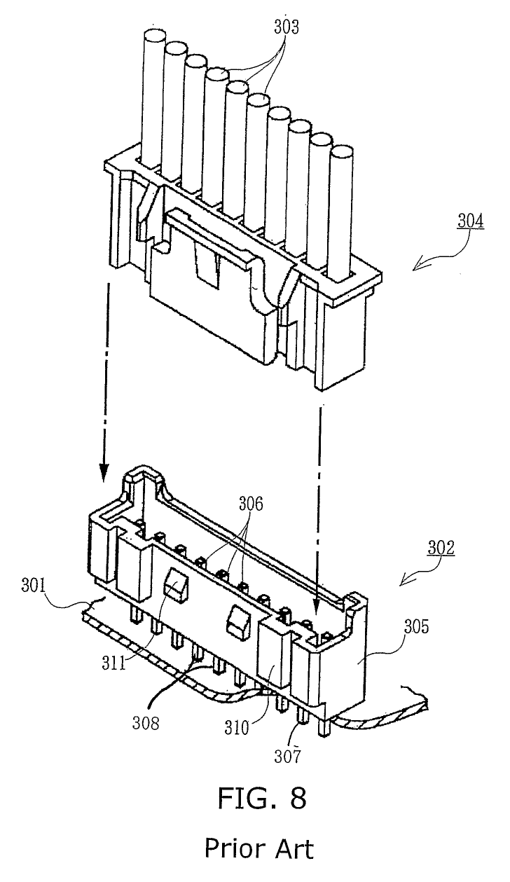

As shown in FIG. 5, the board mounted connector 10 is mounted onto the board 41 such that the bottom surface 21 of the housing 11 faces the upper surface of the board 41. The downwardly projecting tip ends of the terminals 12 are inserted into the corresponding through-holes, and the positioning projection 13 is fitted into an unillustrated positioning recess formed on the board 41. Thus, the board mounted connector 10 is attached in place to the board 41 in a predetermined orientation. As shown in FIGS. 6 and 7, tip ends of the terminals 12 pass through the through-holes and project from the lower surface of the board 41. The terminals 12 are fixed to the through-holes of the board 41 by means of soldering, whereby the board mounted connector 10 is fixed to the board 41.

The board 41 has a surface around the housing 11 to which the tamper-proof cover 42 can be bonded only after the board mounted connector 10 is soldered to the board 41. The tamper-proof cover 42, which surrounds the housing 11, is a thin plate formed of an insulative resin such as acrylic or a sheet formed of an insulative resin such as polyamide. However, the tamper-proof cover 42 may be formed of any non-conductive material that can be formed into a thin plate or sheet. The tamper-proof cover 42 may be solid or hollow and a depression may be formed on the surface facing the board 41. No limitation is imposed on the cross-sectional shape of the tamper-proof cover 42 as long as the tamper-proof cover 42 can cover an area of the board 41 immediately surrounding the housing 11. The tamper-proof cover 42 desirably has a thickness of 0.2 mm or greater. The tamper-proof cover 42 preferably has an adhesive layer on its one face, and is bonded to the upper surface of the board 41 by use of the adhesive layer. Where the tamper-proof cover 42 has no adhesive layer, the tamper-proof cover 42 may be bonded to the upper surface of the board 41 by use of an adhesive applied to the upper surface of the board 41 or by ultrasonic welding.

As stated previously, opening 42a formed in the tamper-proof cover 42 has a closed circumference identical in planar shape and size with the bottom surface 21 of the housing 11 of the board mounted connector 10. Because the tamper-proof cover 42 is bonded to the board 41 with the opening 42a immediately surrounding the board mounted connector 10, no gap is formed between the inner circumference of the opening 42a and the side surfaces of the housing 11. Since the contour of the bottom surface 21 of the housing 11 is a generally rectangular shape having four sides, the opening 42a can be easily formed.

Since the end and side surfaces do not project outwardly from a plane vertically extending from the corresponding longitudinally extending side of the bottom surface 21, which includes the contour line, the tamper-proof cover 42 can be easily moved in contact with the board 41 while the housing easily passing through the opening 42a. Since the opening 42a is identical in planar shape and size with the bottom surface 21 of the housing 11, when the tamper-proof cover 42 is bonded to the upper surface of the board 41, no gap is formed between the inner circumference of the opening 42a and the side surfaces of the housing 11.

Accordingly, it is possible to prevent a probe from being inserted not only between the board and the board mounted housing but also between the edge of the opening 42a of the tamper-proof cover 42 and the side surfaces of the housing 11 to thereby prevent illegal action.

Since two of the end surfaces and one side surface are planar with the planes extending perpendicular to the bottom surface 21 and are smooth, these surfaces can be used where the board mounted connector 10 is transported by use of automatic equipment equipped with a robot hand, manipulator, or the like in the course of an operation of assembling the board mounted connector 10 and mounting it onto the board 41.

While the preferred embodiment of the invention has been shown and described, it will be apparent to those skilled in the art that changes and modifications may be made therein without departing from the spirit of the invention, the scope of which is defined by the appended claims.

1. A board mounted connector comprising:
a housing which is mateable with a counterpart connector; and
terminals fixed to the housing, the terminals having one end designed to be connected to a circuit board and another end designed to be connected to corresponding terminals of the counterpart connector,
the housing having a bottom surface facing the circuit board, two end surfaces and two side surfaces extending upwardly from the peripheral edge of the bottom surface, the end and side surfaces forming planes which extend from the peripheral edge of the bottom surface to be perpendicular to the bottom surface, and
the end and side surfaces defining a peripheral wall with upper and lower portions all of which are located within the planes extending from the peripheral edge of the bottom surface.

2. A board mounted connector according to claim 1, wherein the lower portion of the wall being within a predetermined vertical distance as measured from the bottom surface, and the end and side surfaces of the lower wall forming a periphery the same as the periphery formed by the planes.

3. A board mounted connector according to claim 2 wherein at last one surface of the upper portion of the wall includes a recess forming a locking engagement member which can lock onto an engagement arm of the counterpart connector.

4. A board mounted connector according to claim 2, wherein the end and side surfaces include a cutaway whose lower end is opened outwardly at a boundary between the bottom surface and the side surfaces, the upper end of the cutaway being located within the predetermined vertical range.

5. A board mounted connector according to claim 4, wherein the bottom surface includes a recess portion which communicates with the cutaway and surrounds the terminal members.

6. A board mounted connector according to any one of claim 2, wherein the peripheral edge of the bottom surface forms a rectangular contour.

7. A board mounted connector assembly including a board mounted connector and a cover member which can be bonded to a printed circuit board comprising:
the board mounted connector including
a housing which is mateable with a counterpart connector; and
terminals fixed to the housing, the terminals having one end designed to be connected to a circuit board and another end designed to be connected to corresponding terminals of the counterpart connector,
the housing having a bottom surface facing the circuit board, two end surfaces and two side surfaces extending upwardly from the peripheral edge of the bottom surface, the end and side surfaces forming planes which extend from the peripheral edge of the bottom surface to be perpendicular to the bottom surface, and
the end and side surfaces defining a peripheral wall with upper and lower portions all of which wall are located within the planes extending from the peripheral edge of the bottom surface; and
the cover member having an opening which is identical in shape and size with the contour of the bottom surface.
